(19) United States
(12) Patent Application Publication
(10) Pub. No.: US 2024/0385348 A1
(43) Pub. Date: Nov. 21, 2024

(54) YIELD PREDICTION METHOD FOR FRACTURED HORIZONTAL WELL BASED ON SIMULATED SPECIAL MECHANISMS OF SHALE GAS

(71) Applicant: Chongqing University of Science and Technology, Chongqing (CN)

(72) Inventors: Zuping XIANG, Chongqing (CN); Yangyang DING, Chongqing (CN); Xiang AO, Chongqing (CN); Zhonghua LIU, Chongqing (CN); Tao BU, Chongqing (CN); Qianhua XIAO, Chongqing (CN); Xinjian MA, Chongqing (CN); Xiaotao ZHANG, Chongqing (CN); Zhonghua CHEN, Chongqing (CN); Junbiao HU, Chongqing (CN)

(21) Appl. No.: 18/629,999

(22) Filed: Apr. 9, 2024

(30) Foreign Application Priority Data
May 17, 2023 (CN) 2023105554277

(51) Int. Cl. G01V 20/00; G06F 30/28; G06F 111/10; G06F 113/08; G06F 119/22

(52) U.S. Cl. CPC G01V 20/00; G06F 30/28; G06F 2111/10; G06F 2113/08; G06F 2119/22

(57) ABSTRACT

The present disclosure relates to a yield prediction method for a fractured horizontal well based on simulated special mechanisms of shale gas. The method includes: establishing a gas-phase seepage model of a shale reservoir matrix system with consideration of special mechanisms of Knudsen diffusion, surface diffusion, slippage effect, and desorption influenced by a fracturing fluid; establishing gas-phase and water-phase seepage models of a shale reservoir fracture system with consideration of influences of a sanding concentration, a particle size of a proppant, and a closure stress on a fracturing fracture; establishing a gas-water two-phase seepage model of a shale gas well; then solving the gas-water two-phase seepage model of the shale gas well to obtain a yield of the shale gas well; performing production history fitting; and performing production simulation and yield prediction under different production allocations, using maximum cumulative gas production as an indicator to determine a reasonable production allocation.

### CROSS REFERENCE TO RELATED APPLICATION

This patent application claims the benefit and priority of Chinese Patent Application No. 2023105554277, filed with the China National Intellectual Property Administration on May 17, 2023, the disclosure of which is incorporated by reference herein in its entirety as part of the present application.

### TECHNICAL FIELD

The present disclosure relates to the technical field of shale gas yield prediction, and in particular, to a yield prediction method for a fractured horizontal well based on simulated special mechanisms of shale gas.

### BACKGROUND

A shale reservoir matrix has an extremely low nanopore permeability and is accompanied by complex seepage mechanisms such as desorption, mass transfer diffusion of gas in nanopores, slippage seepage, and Darcy seepage in a fracture.

Existing studies have found that there exists a certain amount of water with a saturation lower than an irreducible water saturation in the shale reservoir state and the water has a certain influence on the adsorption, desorption, and flow of gas and hence an influence on the yield of a shale gas well. When fracturing reformation is made on a reservoir, under the action of a differential pressure between a breakdown pressure and a pressure in matrix pores and a capillary force, part of a fracturing fluid will be imbibed into the matrix pores, thereby increasing a water saturation in the matrix pores and affecting the desorption and flow capabilities of shale gas. In a shale reservoir, a flowback rate of a fracturing fluid is generally 10% to 50%, and a large amount of fracturing fluid will be retained in the shale reservoir and mainly stay in a fracture. Consequently, during shale gas production, there exists a gas-water two-phase flow in the fracture such that the effective permeability of gas is seriously reduced, thereby influencing the yield of the shale gas well. Due to different fracturing process parameters during fracturing, flow conductivity changing regularities of fracturing fractures are different in depressurizing production. During depressurizing production, a closure pressure acting on the fracturing fracture of the reservoir will become increasingly great, and a proppant will be embedded and broken, leading to reduced flow conductivity of the fracturing fracture.

Existing yield prediction methods for shale gas rarely take into account the influence of water saturation change in matrix pores, and a yield prediction model with consideration of the influence of fracturing process parameters is even rarer. As a result, the existing yield prediction methods for shale gas have great errors in yield prediction of shale gas reservoirs.

### SUMMARY

An objective of the present disclosure is to provide a yield prediction method for a fractured horizontal well based on simulated special mechanisms of shale gas, which is intended to solve the technical problem that existing yield prediction methods of shale gas neglect the influences of a water saturation in matrix pores and fracturing process parameters on the yield of shale gas reservoirs in the prior art.

To achieve the above objective, the present disclosure proposes a yield prediction method for a fractured horizontal well based on simulated special mechanisms of shale gas, including the following steps:
establishing a gas-phase seepage model of a shale reservoir matrix system with consideration of special mechanisms;
establishing gas-phase and water-phase seepage models of a shale reservoir fracture system with consideration of special mechanisms;
establishing a gas-water two-phase seepage model of a shale gas well based on the gas-phase seepage model of the shale reservoir matrix system and the gas-phase and water-phase seepage models of the shale reservoir fracture system;
solving the gas-water two-phase seepage model of the shale gas well by using a numerical simulation method to obtain a yield of the shale gas well;
performing production history fitting by adjusting related parameters; and
performing production simulation and yield prediction under different production allocations according to parameter values obtained after the production history fitting.

The establishing a gas-phase seepage model of a shale reservoir matrix system with consideration of special mechanisms of Knudsen diffusion, surface diffusion, slippage effect, and desorption influenced by a fracturing fluid may include:
establishing a shale gas desorption model under the influence of the fracturing fluid, and unifying units of the shale gas desorption model to m³/m³ to obtain:

$${V}_{ab} = \{ ( 1 - {θ}_{w} ) {V}_{1} exp \{ - {[ \frac{RT}{E} ln ( \frac{{{P}_{c} ( \frac{T}{{T}_{c}} )}^{m}}{P} ) ]}^{κ} \} + {V}_{c} \} {ρ}_{rock} \times {10}^{- 3}$$

where P represents a reservoir pressure, MPa; R represents a gas constant, 8.314 J/(mol·K); T represents a reservoir temperature, K; V_{ab} represents an absolute adsorbed gas quantity of an adsorbent, m³/t; E represents adsorption characteristic energy, J/mol; P_{c} represents a critical pressure of methane, 4.59 MPa; T_{c} represents a critical temperature of methane, 190.55K; m represents an adsorption system coefficient, dimensionless; κ represents a surface adsorption potential maldistribution coefficient of the adsorbent, which is 2 to 6; Vₗ represents a maximum gas adsorption quantity when θ_{w}=0, m³/t; θ_{w} represents a surface coverage of water; V_{c} represents a residual gas adsorption quantity, m³/t; and Pₘ represents a test pressure or a pressure in matrix pores, MPa;
comprehensively characterizing a transport mechanism of the shale gas in matrix nanopores by using an apparent permeability, where the transport mechanism includes Knudsen diffusion, surface diffusion, sliding flow, and viscos flow, and deriving the following equation:

$${K}_{m} = \frac{{ϕ}_{m}}{τ} \{ \frac{{r}^{2} ( 1 + α {K}_{n} )}{8 ( 1 + {K}_{n} )} ( 1 + \frac{4 {K}_{n}}{1 + {bK}_{n}} ) + \frac{2 {μ}_{g} r}{3 {ρ}_{g} ( 1 + \frac{1}{{K}_{n}} )} \sqrt{\frac{8 M}{RT π}} + \frac{{μ}_{g} {D}_{s} {ρ}_{rock} {ρ}_{st} {V}_{ab} ( 1 + {ϕ}_{m} )}{( 1 - {θ}_{g} ) {P}_{m}} ∇ {P}_{m} \}$$

where Kₘ represents the apparent permeability, μm²; Kₙ represents a Knudsen number; ϕₘ represents a matrix porosity, dimensionless; τ represents a tortuosity of nanopores, dimensionless; μ_{g} represents a gas viscosity in pores, mPa·s; α represents a rare effect coefficient, dimensionless; ϕ represents a shale porosity, %; Ds represents a surface diffusion coefficient of the shale gas, m²/s; ρ_{rock} and ρₛₜ represent a rock density and a gas density under standard conditions, respectively, kg/m³; r represents a matrix pore radius, nm; ρ_{g} represents a gas density, kg/m³; b represents a slip coefficient, b=−1; θ_{g} represents a surface coverage of a gas phase; and M represents a molecular mass of a gas, g/mol⁻¹;
where the rare effect coefficient is expressed as:

$$α = \frac{128}{15 {π}^{2}} {tan}^{- 1} ( 4 {Kn}^{0.4} )$$

the surface diffusion coefficient of the shale gas is expressed as:

$${D}_{s} = \frac{8.29 \times {10}^{- 7} \sqrt{T} exp ( - \frac{{ΔΓ}^{0.8}}{RT} )}{1 - {θ}_{g}}$$

where ΔΓ represents isosteric heat of adsorption, J/mol;
establishing the gas-phase seepage model of the shale reservoir matrix system, and transforming the gas-phase seepage model of the shale reservoir matrix system into an equation of continuity of two-dimensional plane flow as follows:

$$\frac{\partial }{\partial x} ( {A}_{x} \frac{{K}_{m} {ρ}_{g}}{{μ}_{g}} \frac{\partial {P}_{m}}{\partial x} ) Δ x + \frac{\partial }{\partial y} ( {A}_{y} \frac{{K}_{m} {ρ}_{g}}{{μ}_{g}} \frac{\partial {P}_{m}}{\partial y} ) Δ y = {V}_{b} \frac{\partial }{\partial t} ( {ϕ}_{m} {ρ}_{g} + {ρ}_{gsc} {V}_{ab} ) - {q}_{c}$$

where q_{c} represents a gas channeling quantity between the shale reservoir matrix system and the shale reservoir fracture system, kg/s; Pₘ represents the pressure in the matrix pores, MPa; ρ_{gsc} represents a natural gas density in a standard state, kg/m³; Aₓ and A_{y} represent cross-sectional areas of a grid in an x-direction and a y-direction, respectively, m²; Δt represents a time step size, d; and V_{b} represents a volume of a grid block, m³.
where the gas channeling quantity is expressed as:

$${q}_{c} = \frac{2 Δ z Δ {xK}_{m} {ρ}_{g}}{Δ y {μ}_{g}} ( {P}_{m} - {P}_{fg} )$$

where Δx represents a size of a grid block of a matrix apparent permeability in the x-direction; Δy represents a size of the grid block of the matrix apparent permeability in the y-direction; Δz represents a size of the grid block of the matrix apparent permeability in a z-direction; and P_{fg} represents a gas phase pressure in a fracture, MPa.

The establishing gas-phase and water-phase seepage models of a shale reservoir fracture system with consideration of influences of a sanding concentration, a particle size of a proppant, and a closure stress may include:
revealing an artificial fracture deformation regularity caused by different factors through a real rock slab flow conductivity experiment, and establishing a reliable quantitative description equation, where the flow conductivity F_{CD} of a fracture is expressed as:

$${F}_{CD} = \frac{{C}_{p}}{5} {F}_{CD 0} {e}^{- {C}_{f} ( {P}_{c} - {P}_{c 0} )} = {K}_{f} {W}_{f}$$

where F_{CD} represents the flow conductivity of a prop fracture under the action of a current closure stress, D·cm; F_{CDO} represents the flow conductivity of the prop fracture under an initial closure stress, D·cm; C_{f} represents a stress sensitivity coefficient of a shale fracturing fracture, MPa⁻¹; P_{c} represents the current closure stress, MPa; P_{co} represents the initial closure stress, MPa; Cₚ represents a sanding concentration of the proppant, kg/m²; K_{f} represents a permeability of the prop fracture, μm²; and W_{f} represents a width of the prop fracture, m;
establishing the gas-phase and water-phase seepage models of the shale reservoir fracture system, and transforming the gas-phase and water-phase seepage models of the shale reservoir fracture system into equations of continuity of two-dimensional plane flow as follows:
gas phase:

$$\frac{\partial }{\partial x} ( {A}_{x} \frac{{K}_{f} {K}_{frg} {ρ}_{g}}{{μ}_{fg}} \frac{\partial {P}_{fg}}{\partial x} ) Δ x + \frac{\partial }{\partial y} ( {A}_{y} \frac{{K}_{f} {K}_{frg} {ρ}_{g}}{{μ}_{fg}} \frac{\partial {P}_{fg}}{\partial y} ) Δ y = {V}_{b} \frac{\partial }{\partial t} ( {ϕ}_{f} {ρ}_{g} {S}_{fg} ) + {q}_{c} - {q}_{g}$$

water phase:

$$\frac{\partial }{\partial x} ( {A}_{x} \frac{{K}_{f} {K}_{frw} {ρ}_{w}}{{μ}_{fw}} \frac{\partial {P}_{fw}}{\partial x} ) Δ x + \frac{\partial }{\partial y} ( {A}_{y} \frac{{K}_{f} {K}_{frw} {ρ}_{w}}{{μ}_{fw}} \frac{\partial {P}_{fw}}{\partial y} ) Δ y = {V}_{b} \frac{\partial }{\partial t} ( {ϕ}_{f} {ρ}_{w} {S}_{fw} ) - {q}_{w}$$

where K_{frg} represents a relative permeability of the gas phase in the fracture, μm²; K_{frw} represents a relative permeability of the water phase in the fracture, μm₂; S_{fg} represents a water saturation of the shale reservoir fracture system, %; S_{fw} represents a water saturation of the shale reservoir fracture system, %; ϕ_{f} represents a fracture porosity, %; q_{w} represents a mass flow rate of water flowing from the fracture into a wellbore, kg/s; q_{g} represents a mass flow rate of gas flowing from the fracture into the wellbore, kg/s; and μ_{fw} represents a viscosity of the water phase in the fracture, mPa·s.

The establishing a gas-water two-phase seepage model of a shale gas well based on the gas-phase seepage model of the shale reservoir matrix system and the gas-phase and water-phase seepage models of the shale reservoir fracture system may include:
expressing the mass flow rates of the gas phase and the water phase flowing from the fracture into the wellbore by the following two formulas, and characterizing the mass flow rates of gas and water flowing from the fracture into the wellbore in a grid of a producing well by the two formulas:

$${q}_{g} = \frac{2 {πρ}_{g} {K}_{f} {K}_{frg} {W}_{f}}{{μ}_{fg} ( ln \frac{{r}_{eq}}{{r}_{w}} + S )} ( {P}_{HE} - {P}_{wf} )$$

$${q}_{w} = \frac{2 {πρ}_{w} {K}_{f} {K}_{frw} {W}_{f}}{{μ}_{w} ( ln \frac{{r}_{eq}}{{r}_{w}} + S )} ( {P}_{HE} - {P}_{wf} )$$

where r_{eq} represents an equivalent bottom-hole radius, m; r_{w} represents a well radius, which is 0.1 m; P_{HE} represents a pressure of a grid block where the wellbore is located, MPa; P_{wf} represents a flowing bottom-hole pressure, MPa; and S represents a skin coefficient, dimensionless; and
combining the equation of continuity for the gas phase established in the shale reservoir matrix system and the equations of continuity for gas and water established in the shale reservoir fracture system to obtain a basic seepage equation of shale gas with consideration of a special seepage mechanism:

$$\{ \begin{matrix}\frac{\partial }{\partial x} ( {A}_{x} \frac{{K}_{m} {ρ}_{g}}{{μ}_{g}} \frac{\partial {P}_{m}}{\partial x} ) Δ x + \frac{\partial }{\partial y} ( {A}_{y} \frac{{K}_{m} {ρ}_{g}}{{μ}_{g}} \frac{\partial {P}_{m}}{\partial y} ) Δ y = {V}_{b} \frac{\partial }{\partial t} ( {ϕ}_{m} {ρ}_{g} + \\ {ρ}_{gsc} {V}_{ab} ) - {q}_{c} \\ \frac{\partial }{\partial x} ( {A}_{x} \frac{{K}_{f} {K}_{frg} {ρ}_{g}}{{μ}_{g}} \frac{\partial {P}_{fg}}{\partial x} ) Δ x + \frac{\partial }{\partial y} ( {A}_{y} \frac{{K}_{f} {K}_{frg} {ρ}_{g}}{{μ}_{g}} \frac{\partial {P}_{fg}}{\partial y} ) Δ y = \\ {V}_{b} \frac{\partial }{\partial t} ( {ϕ}_{f} {ρ}_{g} {S}_{fg} ) + {q}_{c} - {q}_{g} \\ \frac{\partial }{\partial x} ( {A}_{x} \frac{{K}_{f} {K}_{frw} {ρ}_{w}}{{μ}_{fw}} \frac{\partial {P}_{fw}}{\partial x} ) Δ x + \frac{\partial }{\partial y} ( {A}_{y} \frac{{K}_{f} {K}_{frw} {ρ}_{w}}{{μ}_{fw}} \frac{\partial {P}_{fw}}{\partial y} ) Δ y = \\ {V}_{b} \frac{\partial }{\partial t} ( {ϕ}_{f} {ρ}_{w} {S}_{fw} ) - {q}_{w}\end{matrix}$$

where before numerical simulation and solving of the basic seepage equation of shale gas, an initial condition and a boundary condition need to be defined; definite conditions of models include boundaries conditions and initial conditions of the shale reservoir fracture and matrix systems, and assuming that the initial pressures of the shale reservoir fracture and matrix systems are the same, an initial pressure condition is obtained as follows:

$${P}_{k} ( x , y , t ) {\vert}_{t = 0} = {P}_{m} ( x , y , t ) {\vert}_{t = 0} = {P}_{f} ( x , y , t ) {\vert}_{t = 0} = {P}_{i}$$

since a research object is an enclosed unit, an outer boundary of a mathematical model is enclosed, and an inner boundary is production under a fixed flowing bottom-hole pressure, and an inner boundary condition of the model is as follows:

$$\frac{\partial {P}_{f}}{\partial n} {\vert}_{{Γ}_{I}} = {P}_{wf}$$

and an outer boundary condition is as follows:

$$\frac{\partial {P}_{f}}{\partial n} {\vert}_{{Γ}_{o}} = 0 , \frac{\partial {P}_{m}}{\partial n} {\vert}_{{Γ}_{o}} = 0 , \frac{\partial {P}_{k}}{\partial n} {\vert}_{{Γ}_{o}} = 0$$

where Γ_{I} and Γₒ represent the outer boundary and inner boundary conditions, respectively.

The solving the gas-water two-phase seepage model of the shale gas well by using a numerical simulation method to obtain a yield of the shale gas well may include:

Discretizing the equations in a format of block centered finite difference by using an implicit pressure explicit saturation (IMPES) difference method to obtain corresponding difference equations:
A gas-phase difference equation of the shale reservoir matrix system:

$${T}_{mxi + \frac{1}{2} , j} ( {P}_{m i + 1 , j}^{n + 1} - {P}_{m i , j}^{n + 1} ) - {T}_{mxi - \frac{1}{2} , j} ( {P}_{m i , j}^{n + 1} - {P}_{m i - 1 , j}^{n + 1} ) + {T}_{myi , j + \frac{1}{2}} ( {P}_{m i , j + 1}^{n + 1} - {P}_{m i , j}^{n + 1} ) - {T}_{myi , j - \frac{1}{2}} ( {P}_{m i , j}^{n + 1} - {P}_{m i , j - 1}^{n + 1} ) = \frac{{V}_{b}}{Δ t} {\overline{C}}_{m t} ( {P}_{fgi , y}^{n + 1} - {P}_{fgi , j}^{n} ) - {q}_{c}^{n}$$

A gas-phase difference equation of the shale reservoir fracture system:

$${T}_{fgxi + \frac{1}{2} , j} ( {P}_{fgi + 1 , j}^{n + 1} - {P}_{fgi , j}^{n + 1} ) - {T}_{fgxi - \frac{1}{2} , j} ( {P}_{fgi , j}^{n + 1} - {P}_{fgi - 1 , j}^{n + 1} ) + {T}_{fgyi , j + \frac{1}{2}} ( {P}_{fgi , j + 1}^{n + 1} - {P}_{fgi , j}^{n + 1} ) - {T}_{fgyi , j - \frac{1}{2}} ( {P}_{fgi , j}^{n + 1} - {P}_{fgi , j - 1}^{n + 1} ) = \frac{{V}_{b}}{Δ t} {ϕ}_{f} {ρ}_{g} ( {C}_{f} + {C}_{fg} {S}_{fg} ) ( {P}_{fgi , j}^{n + 1} - {P}_{fgi , j}^{n} ) - {q}_{g}^{n} + {q}_{c}^{n}$$

A water-phase difference equation of the shale reservoir fracture system:

$${T}_{fwxi + \frac{1}{2} , j} ( {P}_{fwi + 1 , j}^{n + 1} - {P}_{fwi , j}^{n + 1} ) - {T}_{fwxi - \frac{1}{2} , j} ( {P}_{fwi , j}^{n + 1} - {P}_{fwi - 1 , j}^{n + 1} ) + {T}_{fwyi , j + \frac{1}{2}} ( {P}_{fwi , j + 1}^{n + 1} - {P}_{fwi , j}^{n + 1} ) - {T}_{fwyi , j - \frac{1}{2}} ( {P}_{fwi , j}^{n + 1} - {P}_{fwi , j - 1}^{n + 1} ) = \frac{{V}_{b}}{Δ t} {ϕ}_{f} {ρ}_{w} ( {C}_{f} + {C}_{fw} {S}_{fw} ) ( {P}_{fwi , j}^{n + 1} - {P}_{fwi , j}^{n} ) - {q}_{w}^{n}$$

$$where$$

$${T}_{mxi \pm \frac{1}{2} , j} = {{A}_{x} ( \frac{{K}_{m} {ρ}_{g}}{{μ}_{g}} )}_{i \pm \frac{1}{2} , j} \frac{Δ {y}_{j}}{Δ {x}_{i \pm \frac{1}{2} , j}}$$

$$and$$

$${T}_{myi , j \pm \frac{1}{2}} = {A}_{y} \frac{{( \frac{{K}_{m} {ρ}_{m g}}{{μ}_{g}} )}_{i , j \pm \frac{1}{2}}}{Δ {y}_{i , j \pm \frac{1}{2}}}$$

represent conductivities of gas in the x-direction and the y-direction of the shale reservoir matrix system, respectively;

$${T}_{fgxi \pm \frac{1}{2} , j} = {{A}_{x} ( \frac{{K}_{f} {K}_{frg} {ρ}_{fg}}{{μ}_{fg}} )}_{i \pm \frac{1}{2} , j} \frac{Δ {y}_{j}}{Δ {x}_{i \pm \frac{1}{2} , j}}$$

$$and$$

$${T}_{fgyi , j \pm \frac{1}{2}} = {A}_{y} \frac{{( \frac{{K}_{f} {K}_{frg} {ρ}_{fg}}{{μ}_{fg} Δ y} )}_{i , j \pm \frac{1}{2}}}{Δ {y}_{i , j \pm \frac{1}{2}}} ,$$

represent conductivities of gas in the x-direction and the y-direction of the shale reservoir fracture system, respectively;

$${T}_{fwyi \pm \frac{1}{2} , j} = {{A}_{y} ( \frac{{K}_{f} {K}_{frw} {ρ}_{fw}}{{μ}_{fw}} )}_{i \pm \frac{1}{2} , j} \frac{Δ {y}_{j}}{Δ {x}_{i \pm \frac{1}{2} , j}}$$

$$and$$

$${T}_{fwyi , j \pm \frac{1}{2}} = {A}_{y} \frac{{( \frac{{K}_{f} {K}_{frw} {ρ}_{fw}}{{μ}_{fw} Δ y} )}_{i , j \pm \frac{1}{2}}}{Δ {y}_{i , j \pm \frac{1}{2}}}$$

represent conductivities of the water phase in the x-direction and the y-direction of the shale reservoir fracture system, respectively;

$${\overline{C}}_{mt} = {ϕ}_{m} {ρ}_{m g} {C}_{mt} + {ρ}_{gsc} \frac{{V}_{ab}}{\partial {P}_{m}} :$$

represents a total compressibility of the matrix, MPa⁻¹; C_{f} represents a total compressibility of the shale reservoir fracture system, MPa⁻¹; C_{fw} represents a coefficient of compressibility of the water phase in the shale reservoir fracture system, MPa⁻¹; C_{fg} represents a coefficient of compressibility of the gas phase in the shale reservoir fracture system, MPa⁻¹; P_{fg} represents a gas-phase pressure in the fracture, MPa; P_{fw} represents a water-phase pressure in the fracture, MPa; and Cₘₜ represents a coefficient of compressibility when adsorption and desorption are not considered in the matrix, MPa^{31 1}.

The yield prediction method for a fractured horizontal well based on simulated special mechanisms of shale gas proposed in the present disclosure includes: establishing a gas-phase seepage model of a shale reservoir matrix system with consideration of special mechanisms of Knudsen diffusion, surface diffusion, slippage effect, and desorption influenced by a fracturing fluid; establishing gas-phase and water-phase seepage models of a shale reservoir fracture system with consideration of influences of a sanding concentration, a particle size of a proppant, and a closure stress; establishing a gas-water two-phase seepage model of a shale gas well based on the gas-phase seepage model of the shale reservoir matrix system and the gas-phase and water-phase seepage models of the shale reservoir fracture system; solving the gas-water two-phase seepage model of the shale gas well by using a numerical simulation method to obtain a yield of the shale gas well; performing production history fitting by adjusting related parameters; and performing production simulation and yield prediction under different production allocations according to parameter values obtained after the production history fitting. Based on the established models for yield prediction of shale gas, special mechanisms of the influences of multi-mechanism flow of gas in matrix nanopores and containing water on desorption of shale gas and the influences of fracturing process parameters on the yield of the shale gas well are taken into account, and the accuracy of predicting the yield of the shale gas well is improved and a theoretical support is provided for reasonable production allocations of the shale gas well under different conditions.

### BRIEF DESCRIPTION OF THE DRAWINGS

To describe the technical solutions in the embodiments of the present disclosure or in the prior art more clearly, the accompanying drawings needed in describing the embodiments or the prior art will be briefly described below. Apparently, the accompanying drawings in the following description show merely some embodiments of the present disclosure, and other drawings can be derived from the accompanying drawings by those of ordinary skill in the art without creative efforts.

FIG. 1 is a flowchart of a yield prediction method for a fractured horizontal well based on simulated special mechanisms of shale gas according to the present disclosure;

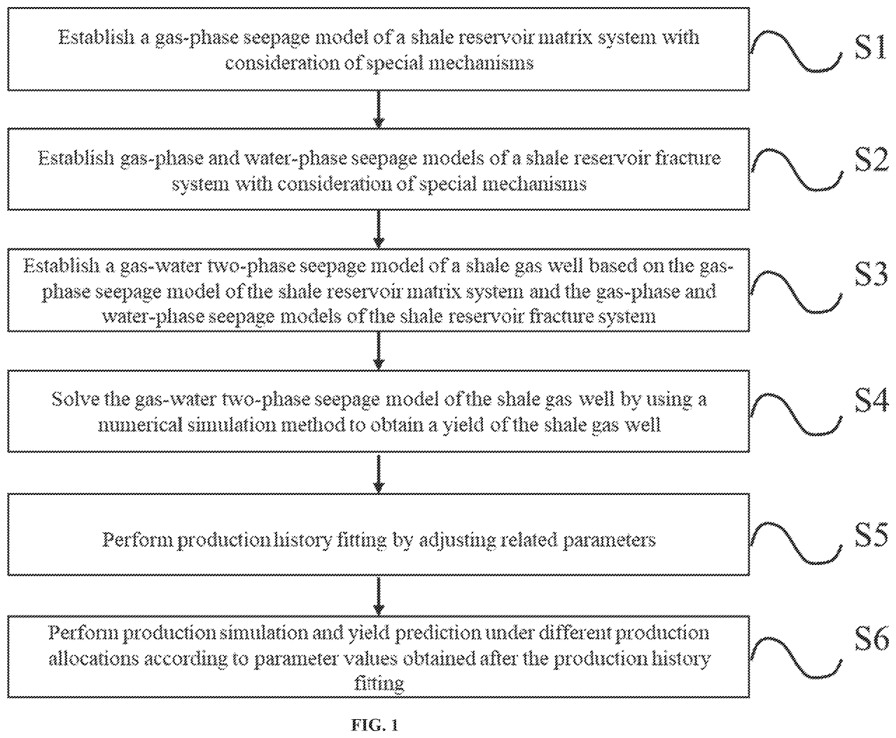

FIG. 2 illustrates a daily gas production vs cumulative gas production relationship curve of a shale gas well under different water saturations;

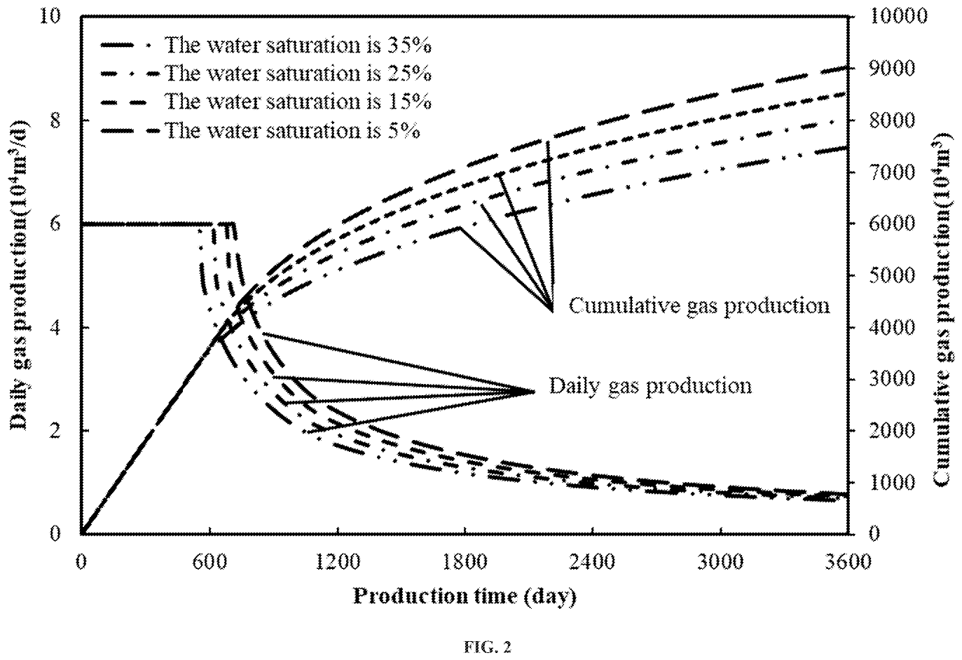

FIG. 3 illustrates a daily gas production vs cumulative gas production relationship curve of a shale gas well under different sanding concentrations of a proppant;

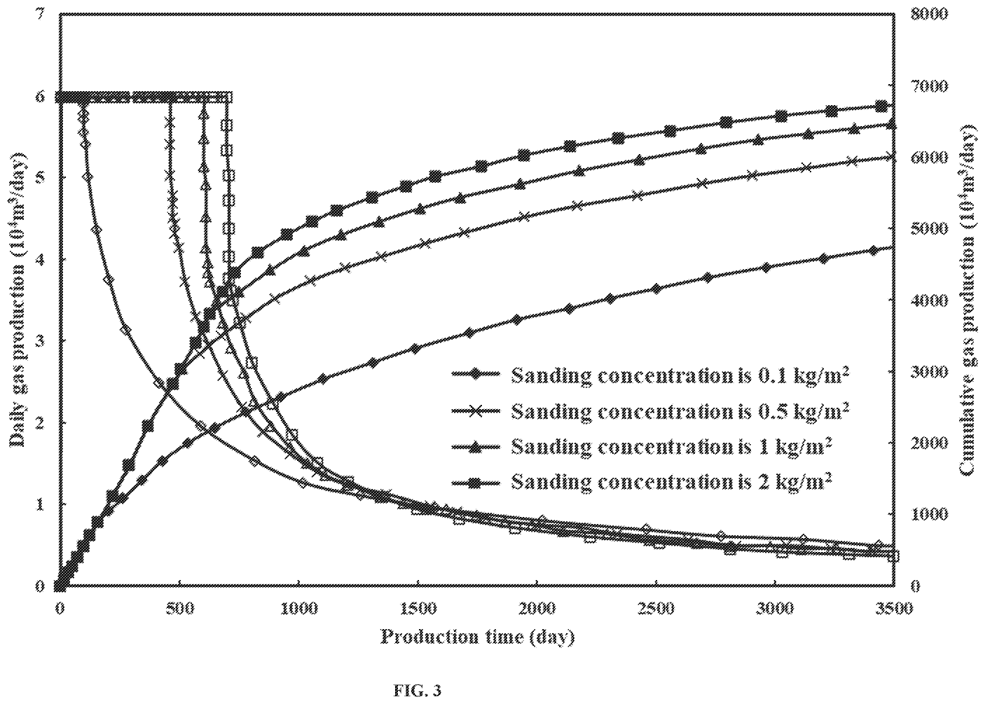

FIG. 4 illustrates a daily gas production vs cumulative gas production relationship curve of a shale gas well under different particle sizes of proppants;

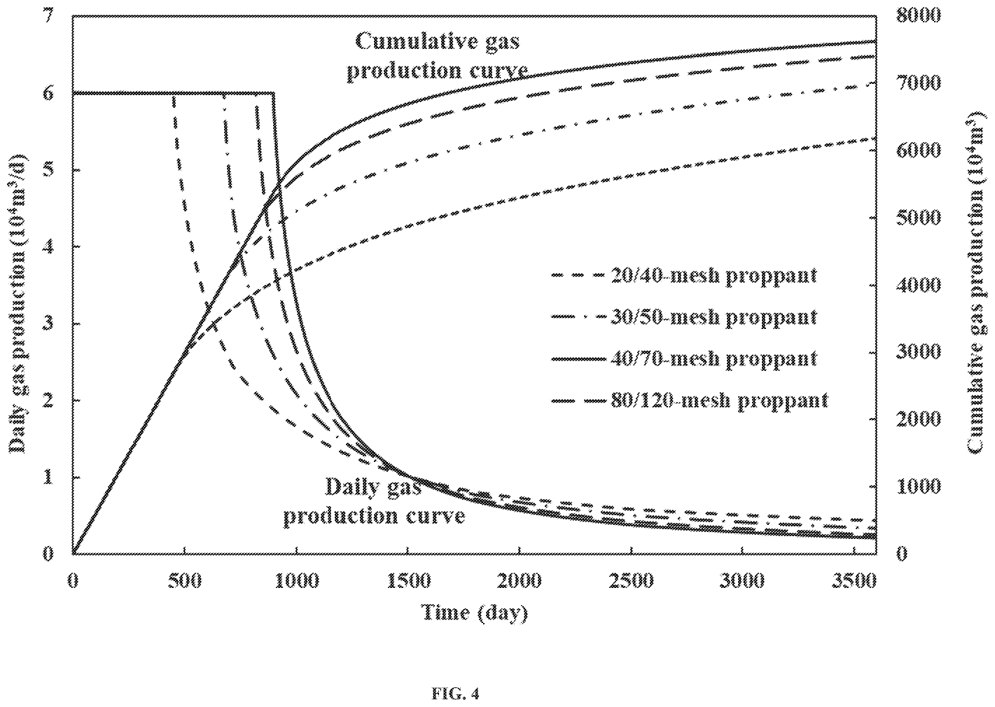

FIG. 5 illustrates a daily gas production vs cumulative gas production relationship curve of a shale gas well in consideration of different seepage mechanisms;

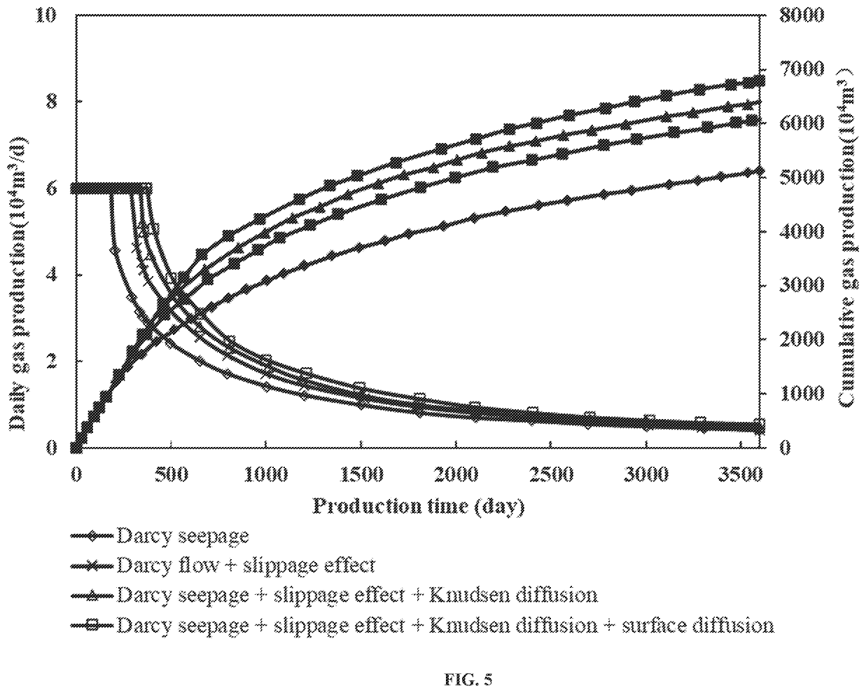

FIG. 6 illustrates a production curve under different production allocation conditions according to the present disclosure; and

FIG. 7 illustrates a cumulative gas production vs stable production time under different production allocation conditions according to the present disclosure.

### DETAILED DESCRIPTION OF THE EMBODIMENTS

The present disclosure provides a yield prediction method for a fractured horizontal well based on simulated special mechanisms of shale gas, including the following steps:

S1: establish a gas-phase seepage model of a shale reservoir matrix system with consideration of special mechanisms;

S2: establish gas-phase and water-phase seepage models of a shale reservoir fracture system with consideration of special mechanisms;

S3: establish a gas-water two-phase seepage model of a shale gas well based on the gas-phase seepage model of the shale reservoir matrix system and the gas-phase and water-phase seepage models of the shale reservoir fracture system;

S4: solve the gas-water two-phase seepage model of the shale gas well by using a numerical simulation method to obtain a yield of the shale gas well;

S5: perform production history fitting by adjusting related parameters; and

S6: perform production simulation and yield prediction under different production allocations according to parameter values obtained after the production history fitting.

In the present embodiment, the method includes: establish a gas-phase seepage model of a shale reservoir matrix system with consideration of special mechanisms such as Knudsen diffusion, surface diffusion, slippage effect, and desorption influenced by a fracturing fluid; establish gas-phase and water-phase seepage models of a shale reservoir fracture system with consideration of influences of a sanding concentration, a particle size of a proppant, and a closure stress; establish a gas-water two-phase seepage model of a shale gas well based on the gas-phase seepage model of the shale reservoir matrix system and the gas-phase and water-phase seepage models of the shale reservoir fracture system; solve the gas-water two-phase seepage model of the shale gas well by using a numerical simulation method to obtain a yield of the shale gas well; perform production history fitting by adjusting related parameters; and perform production simulation and yield prediction under different production allocations according to parameter values obtained after the production history fitting. Based on the established models for yield prediction of shale gas, special mechanisms of the influences of multi-mechanism flow of gas in matrix nanopores and containing water on desorption of shale gas and the influences of fracturing process parameters on the yield of the shale gas well are taken into account, and the accuracy of predicting the yield of the shale gas well is improved and a theoretical support is provided for reasonable production allocations of the shale gas well under different conditions.

Further, the process of establishing a gas-phase seepage model of a shale reservoir matrix system with consideration of special mechanisms such as Knudsen diffusion, surface diffusion, slippage effect, and desorption influenced by a fracturing fluid includes:
Establish a shale gas desorption model under the influence of the fracturing fluid, and unify units of the shale gas desorption model to m³/m³ to obtain:

$${V}_{ab} = \{ ( 1 - {θ}_{w} ) {V}_{1} exp \{ - {[ \frac{RT}{E} ln ( \frac{{{P}_{c} ( \frac{T}{{T}_{c}} )}^{m}}{P} ) ]}^{κ} \} + {V}_{c} \} {ρ}_{rock} \times {10}^{- 3}$$

where P represents a reservoir pressure, MPa; R represents a gas constant, 8.314 J/(mol·K); T represents a reservoir temperature, K; V_{ab} represents an absolute adsorbed gas quantity of an adsorbent, m³/t; E represents adsorption characteristic energy, J/mol; P_{c} represents a critical pressure of methane, 4.59 MPa; T_{c} represents a critical temperature of methane, 190.55K; m represents an adsorption system coefficient, dimensionless; κ represents a surface adsorption potential maldistribution coefficient of the adsorbent, which is 2 to 6; V₁ represents a maximum gas adsorption quantity when θ_{w}=0, m³/t; θ_{w} represents a surface coverage of water; V_{c} represents a residual gas adsorption quantity, m³/t; and Pₘ represents a test pressure or a pressure in matrix pores, MPa;
Comprehensively characterize a transport mechanism of the shale gas in matrix nanopores by using an apparent permeability, where the transport mechanism includes Knudsen diffusion, surface diffusion, sliding flow, and viscos flow, and deriving the following equation:

$${K}_{m} = \frac{{ϕ}_{m}}{τ} \{ \frac{{r}^{2} ( 1 + α {K}_{n} )}{8 ( 1 + {K}_{n} )} ( 1 + \frac{4 {K}_{n}}{1 - {bK}_{n}} ) + \frac{2 {μ}_{g} r}{3 {ρ}_{g} ( 1 + \frac{1}{{K}_{n}} )} \sqrt{\frac{8 M}{RT π}} + \frac{{μ}_{g} {D}_{s} {ρ}_{rock} {ρ}_{st} {V}_{ab} ( 1 - {ϕ}_{m} )}{( 1 - {θ}_{g} ) {P}_{m}} ∇ {P}_{m} \}$$

where Kₘ represents the apparent permeability, μm²; Kₙ represents a Knudsen number; ϕₘ represents a matrix porosity, dimensionless; τ represents a tortuosity of nanopores, dimensionless; μ_{g} represents a gas viscosity in pores, mPa·s; α represents a rare effect coefficient, dimensionless; ϕ represents a shale porosity, %; Ds represents a surface diffusion coefficient of the shale gas, m²/s; ρ_{rock} and ρₛₜ represent a rock density and a gas density under standard conditions, respectively, kg/m³; r represents a matrix pore radius, nm; ρ_{g} represents a gas density, kg/m³; b represents a slip coefficient, b=−1; θ_{g} represents a surface coverage of a gas phase; and M represents a molecular mass of a gas, g/mol⁻¹;
where the rare effect coefficient is expressed as:

$$α = \frac{128}{15 {π}^{2}} {tan}^{- 1} ( 4 {Kn}^{0.4} )$$

The surface diffusion coefficient of the shale gas is expressed as:

$${D}_{s} = \frac{8.29 \times {10}^{- 7} \sqrt{T} exp ( - \frac{{ΔΓ}^{0.8}}{RT} )}{1 - {θ}_{g}}$$

where ΔΓ represents isosteric heat of adsorption, J/mol;
Establish the gas-phase seepage model of the shale reservoir matrix system, and transform the gas-phase seepage model of the shale reservoir matrix system into an equation of continuity of two-dimensional plane flow as follows:

$$\frac{\partial }{\partial x} ( {A}_{x} \frac{{K}_{m} {ρ}_{g}}{{μ}_{g}} \frac{\partial {P}_{m}}{\partial x} ) Δ x + \frac{\partial }{\partial y} ( {A}_{y} \frac{{K}_{m} {ρ}_{g}}{{μ}_{g}} \frac{\partial {P}_{m}}{\partial y} ) Δ y = {V}_{b} \frac{\partial }{\partial t} ( {ϕ}_{m} {ρ}_{g} + {ρ}_{gsc} {V}_{ab} ) - {q}_{c}$$

where q_{c} represents a gas channeling quantity between the shale reservoir matrix system and the shale reservoir fracture system, kg/s; Pₘ represents the pressure in the matrix pores, MPa; ρ_{gsc} represents a natural gas density in a standard state, kg/m³; Aₓ and A_{y} represent cross-sectional areas of a grid in an x-direction and a y-direction, respectively, m²; Δt represents a time step size, d; and V_{b} represents a volume of a grid block, m³;
where the gas channeling quantity is expressed as:

$${q}_{c} = \frac{2 Δ z Δ {xK}_{m} {ρ}_{g}}{Δ y {μ}_{g}} ( {P}_{m} - {P}_{fg} )$$

where Δx represents a size of a grid block of a matrix apparent permeability in the x-direction; Δy represents a size of the grid block of the matrix apparent permeability in the y-direction; Δz represents a size of the grid block of the matrix apparent permeability in a z-direction; and P_{fg} represents a gas phase pressure in a fracture, MPa.

Further, the process of establishing gas-phase and water-phase seepage models of a shale reservoir fracture system with consideration of influences of a sanding concentration, a particle size of a proppant, and a closure stress includes:
Reveal an artificial fracture deformation regularity caused by different factors through a real rock slab flow conductivity experiment, and establish a reliable quantitative description equation, where the flow conductivity F_{CD} of a fracture is expressed as:

$${F}_{CD} = \frac{{C}_{p}}{5} {F}_{CD 0} {e}^{- {C}_{f} ( {P}_{c} - {P}_{c 0} )} = {K}_{f} {W}_{f}$$

where F_{CD} represents the flow conductivity of a prop fracture under the action of a current closure stress, D·cm; F_{CDO} represents the flow conductivity of the prop fracture under an initial closure stress, D·cm; C_{f} represents a stress sensitivity coefficient of a shale fracturing fracture, MPa⁻¹; P_{c} represents the current closure stress, MPa; P_{co} represents the initial closure stress, MPa; Cₚ represents a sanding concentration of the proppant, kg/m²; K_{f} represents a permeability of the prop fracture, μm²; and W_{f} represents a width of the prop fracture, m;
Establish the gas-phase and water-phase seepage models of the shale reservoir fracture system, and transform the gas-phase and water-phase seepage models of the shale reservoir fracture system into equations of continuity of two-dimensional plane flow as follows:
gas phase:

$$\frac{\partial }{\partial x} ( {A}_{x} \frac{{K}_{f} {K}_{frg} {ρ}_{g}}{{μ}_{g}} \frac{\partial {P}_{fg}}{\partial x} ) Δ x + \frac{\partial }{\partial y} ( {A}_{y} \frac{{K}_{f} {K}_{frg} {ρ}_{g}}{{μ}_{g}} \frac{\partial {P}_{fg}}{\partial y} ) Δ y = {V}_{b} \frac{\partial }{\partial t} ( {ϕ}_{f} {ρ}_{g} {S}_{fg} ) + {q}_{c} - {q}_{g}$$

water phase:

$$\frac{\partial }{\partial x} ( {A}_{x} \frac{{K}_{f} {K}_{frw} {ρ}_{w}}{{μ}_{fw}} \frac{\partial {P}_{fw}}{\partial x} ) Δ x + \frac{\partial }{\partial y} ( {A}_{y} \frac{{K}_{f} {K}_{frw} {ρ}_{w}}{{μ}_{fw}} \frac{\partial {P}_{fw}}{\partial y} ) Δ y = {V}_{b} \frac{\partial }{\partial t} ( {ϕ}_{f} {ρ}_{w} {S}_{fw} ) - {q}_{w}$$

where K_{frg} represents a relative permeability of the gas phase in the fracture, μm²; K_{frw} represents a relative permeability of the water phase in the fracture, μm₂; S_{fg} represents a water saturation of the shale reservoir fracture system, %; S_{fw} represents a water saturation of the shale reservoir fracture system, %; ϕ_{f} represents a fracture porosity, %; q_{w} represents a mass flow rate of water flowing from the fracture into a wellbore, kg/s; q_{g} represents a mass flow rate of gas flowing from the fracture into the wellbore, kg/s; and μ_{fw} represents a viscosity of the water phase in the fracture, mPa·s.

Further, the process of establishing a gas-water two-phase seepage model of a shale gas well based on the gas-phase seepage model of the shale reservoir matrix system and the gas-phase and water-phase seepage models of the shale reservoir fracture system includes:
Express the mass flow rates of the gas phase and the water phase flowing from the fracture into the wellbore by the following two formulas, and characterize the mass flow rates of gas and water flowing from the fracture into the wellbore in a grid of a producing well by the two formulas:

$${q}_{g} = \frac{2 {πρ}_{g} {K}_{f} {K}_{frg} {W}_{f}}{{μ}_{fg} ( ln \frac{{r}_{eq}}{{r}_{w}} + S )} ( {P}_{HE} - {P}_{wf} )$$

$${q}_{w} = \frac{2 {πρ}_{w} {K}_{f} {K}_{frw} {W}_{f}}{{μ}_{w} ( ln \frac{{r}_{eq}}{{r}_{w}} + S )} ( {P}_{HE} - {P}_{wf} )$$

where r_{eq} represents an equivalent bottom-hole radius, m; r_{w} represents a well radius, which is 0.1 m; P_{HE} represents a pressure of a grid block where the wellbore is located, MPa; P_{wf} represents a flowing bottom-hole pressure, MPa; and S represents a skin coefficient, dimensionless; and
Combine the equation of continuity for the gas phase established in the shale reservoir matrix system and the equations of continuity for gas and water established in the shale reservoir fracture system to obtain a basic seepage equation of shale gas with consideration of a special seepage mechanism:

$$\{ \begin{matrix}\frac{\partial }{\partial x} ( {A}_{x} \frac{{K}_{m} {ρ}_{g}}{{μ}_{g}} \frac{\partial {P}_{m}}{\partial x} ) Δ x + \frac{\partial }{\partial y} ( {A}_{y} \frac{{K}_{m} {ρ}_{g}}{{μ}_{g}} \frac{\partial {P}_{m}}{\partial y} ) Δ y = {V}_{b} \frac{\partial }{\partial t} ( {ϕ}_{m} {ρ}_{g} + {ρ}_{gsc} {V}_{ab} ) - {q}_{c} \\ \frac{\partial }{\partial x} ( {A}_{x} \frac{{K}_{f} {K}_{frg} {ρ}_{g}}{{μ}_{g}} \frac{\partial {P}_{fg}}{\partial x} ) Δ x + \frac{\partial }{\partial y} ( {A}_{y} \frac{{K}_{f} {K}_{frg} {ρ}_{g}}{{μ}_{g}} \frac{\partial {P}_{f g}}{\partial y} ) Δ y = {V}_{b} \frac{\partial }{\partial t} ( {ϕ}_{f} {ρ}_{g} {S}_{fg} ) + {q}_{c} - {q}_{g} \\ \frac{\partial }{\partial x} ( {A}_{x} \frac{{K}_{f} {K}_{frw} {ρ}_{w}}{{μ}_{fw}} \frac{\partial {P}_{fw}}{\partial x} ) Δ x + \frac{\partial }{\partial y} ( {A}_{y} \frac{{K}_{f} {K}_{frw} {ρ}_{w}}{{μ}_{fw}} \frac{\partial {P}_{f w}}{\partial y} ) Δ y = {V}_{b} \frac{\partial }{\partial t} ( {ϕ}_{f} {ρ}_{w} {S}_{fw} ) - {q}_{w}\end{matrix}$$

Before numerical simulation and solving of the basic seepage equation of shale gas, an initial condition and a boundary condition need to be defined; definite conditions of models include boundaries conditions and initial conditions of the shale reservoir fracture and matrix systems, and assuming that the initial pressures of the shale reservoir fracture and matrix systems are the same, an initial pressure condition is obtained as follows:

$${P}_{k} ( x , y , t ) {\vert}_{t = 0} = {P}_{m} ( x , y , t ) {\vert}_{t = 0} = {P}_{f} ( x , y , t ) {\vert}_{t = 0} = {P}_{i}$$

Since a research object is an enclosed unit, an outer boundary of a mathematical model is enclosed, and an inner boundary is production under a fixed flowing bottom-hole pressure, and an inner boundary condition of the model is as follows:

$$\frac{\partial {P}_{f}}{\partial n} {\vert}_{{Γ}_{I}} = {P}_{wf}$$

And an outer boundary condition is as follows:

$$\frac{\partial {P}_{f}}{\partial n} {\vert}_{{Γ}_{o}} = 0 , \frac{\partial {P}_{m}}{\partial n} {\vert}_{{Γ}_{o}} = 0 , \frac{\partial {P}_{k}}{\partial n} {\vert}_{{Γ}_{o}} = 0$$

where Γ_{I} and Γₒ represent the outer boundary and inner boundary conditions, respectively.

Further, the process of solving the gas-water two-phase seepage model of the shale gas well by using a numerical simulation method to obtain a yield of the shale gas well includes:

Discretize the equations in a format of block centered finite difference by using an IMPES difference method to obtain corresponding difference equations:
A gas-phase difference equation of the shale reservoir matrix system:

$$T \text{?} ( P \text{?} - P \text{?} ) - T \text{?} ( P \text{?} - P \text{?} ) + T \text{?} ( P \text{?} - P \text{?} ) - T \text{?} ( P \text{?} - P \text{?} ) = \frac{{V}_{b}}{Δ t} \overline{C} \text{?} ( P \text{?} - P \text{?} ) - q \text{?}$$

$$\text{?} \text{indicates text missing or illegible when filed}$$

A gas-phase difference equation of the shale reservoir fracture system:

$$T \text{?} ( P \text{?} - P \text{?} ) - T \text{?} ( P \text{?} - P \text{?} ) + T \text{?} ( P \text{?} - P \text{?} ) - T \text{?} ( P \text{?} - P \text{?} ) = \frac{{V}_{b}}{Δ t} {ϕ}_{f} {ρ}_{g} ( {C}_{f} + {C}_{fg} {S}_{fg} ) ( P \text{?} - P \text{?} ) - q \text{?} + q \text{?}$$

$$\text{?} \text{indicates text missing or illegible when filed}$$

A water-phase difference equation of the shale reservoir fracture system:

$$T \text{?} ( P \text{?} - P \text{?} ) - T \text{?} ( P \text{?} - P \text{?} ) + T \text{?} ( P \text{?} - P \text{?} ) - T \text{?} ( P \text{?} - P \text{?} ) = \frac{{V}_{b}}{Δ t} {ϕ}_{f} ρ \text{?} ( {C}_{f} + C \text{?} S \text{?} ) ( P \text{?} - P \text{?} ) - q \text{?}$$

$$where T \text{?} = {A}_{x} ( \frac{{K}_{m} {ρ}_{g}}{{μ}_{g}} ) \text{?} \frac{Δ {y}_{j}}{Δ x \text{?}} and T \text{?} = {A}_{y} \frac{{( \frac{{K}_{f} {K}_{frg} {ρ}_{fg}}{{μ}_{fg} Δ y} )}_{i , j \pm \frac{1}{2}}}{Δ {y}_{i , j \pm \frac{1}{2}}} ,$$

$$\text{?} \text{indicates text missing or illegible when filed}$$

represent conductivities of gas in the x-direction and the y-direction of the shale reservoir matrix system, respectively;

$$T \text{?} = {A}_{x} ( \frac{{K}_{f} {K}_{frg} {ρ}_{fg}}{{μ}_{fg}} ) \text{?} \frac{Δ {y}_{j}}{Δ x \text{?}} and T \text{?} = {A}_{y} \frac{{( \frac{{K}_{f} {K}_{frg} {ρ}_{fg}}{{μ}_{fg} Δ y} )}_{i , j \pm \frac{1}{2}}}{Δ {y}_{i , j \pm \frac{1}{2}}} ,$$

$$\text{?} \text{indicates text missing or illegible when filed}$$

represent conductivities of gas in the x-direction and the y-direction of the shale reservoir fracture system, respectively;

$$T \text{?} = A \text{?} ( \frac{{K}_{f} K \text{?} ρ \text{?}}{μ \text{?}} ) \text{?} \frac{Δ {y}_{j}}{Δ x \text{?}} and T \text{?} = {A}_{y} \frac{{( \frac{{K}_{f} K \text{?} ρ \text{?}}{μ \text{?} Δ y} )}_{i , j \pm \frac{1}{2}}}{Δ {y}_{i , j \pm \frac{1}{2}}}$$

$$\text{?} \text{indicates text missing or illegible when filed}$$

represent conductivities of the water phase in the x-direction and the y-direction of the shale reservoir fracture system, respectively;

$$\overline{C} \text{?} = {ϕ}_{m} \text{?} {ρ}_{mg} {C}_{mi} + ρ \text{?} \frac{{V}_{ab}}{\partial P \text{?}}$$

$$\text{?} \text{indicates text missing or illegible when filed}$$

represents a total compressibility of the matrix, MPa⁻¹; C_{f} represents a total compressibility of the shale reservoir fracture system, MPa⁻¹; C_{fw} represents a coefficient of compressibility of the water phase in the shale reservoir fracture system, MPa⁻¹; C_{fg} represents a coefficient of compressibility of the gas phase in the shale reservoir fracture system, MPa⁻¹; P_{fg} represents a gas-phase pressure in the fracture, MPa; P_{fw} represents a water-phase pressure in the fracture, MPa; and Cₘₜ represents a coefficient of compressibility when adsorption and desorption are not considered in the matrix, MPa⁻¹.

In the present embodiment, basic simulation parameters shown in the following table are set based on fracturing parameters, reservoir parameters, well parameters, coring data, and the like of a typical shale gas well:

| | | | |
|---|---|---|---|
| Length/width/(m) of a | 2000/300 | ϕm/(%)ₘ/(%) in | 5 |
| simulated unit | | matrix porosity | |
| Gas reservoir thickness | 20 | Flowing bottom-hole | 5 |
| ξ/(m) | | pressure P_{wf}/(MPa) | |
| Intrinsic permeability | 3.2*10⁻⁵ | Stress sensitivity | 0.02 |
| Kₘ/(μm²) of matrix | | coefficient/(—) | |
| Initial pressure | 70 | Adsorbed gas content | 3.3 |
| Pᵢ/(MPa) of formation | | V₁/(m³/t) | |
| Formation | 403 | Pore radius r(nm) | 5 |
| temperature T/(K) | | | |
| Artificial fracture | 2 | Number of effective | 20 |
| porosity φ_{f}/(%) | | fracturing segments | |
| Artificial fracture | 20 | Average | 3 |
| height/(m) | | number N/Z0/(—) of | |
| | | clusters per segment | |
| Artificial | 60 | Knudsen diffusion | 1.467 * 10⁻⁷ |
| fracture //2/(m) | | coefficient | |
| | | Dₖₙ/(m² · s⁻¹) | |
| Flow conductivity | 0.2 | Molecular weight | 16 |
| of artificial | | M_{g}(g · mol⁻¹) | |
| fracture/(μm² · cm) | | of natural gas | |
| Surface diffusion | 6.25*10⁻⁶ | Residual | 0.2 |
| coefficient | | adsorbed gas | |
| Dₛ/(m² · s⁻¹) | | content V_{c}/(m³/t) | |
| Initial water saturation | 85 | Irreducible water | 37 |
| of fracture/% | | saturation/% | |
| Initial viscosity | 0.018 | Adsorption | 15.95 |
| μ_{g}/(mPa · s) of | | characteristic | |
| natural gas | | energy E, kJ/mol | |
| Horizontal wellbore | 1500 | Sanding concentration, | 1 |
| length/(m) | | Cₚ(kg/m²) | |
| Particle size | 40/70 | Predicted | 20 |
| (mesh) of | | production time | |
| proppant | | (year) | |

Firstly, production history fitting is performed. Parameters such as physical dimensions of the artificial fracture, the stress sensitivity coefficient, the adsorbed gas content, the sanding concentration, and the particle size of the proppant are adjusted, and historical production data of the well is fitted; and the values of the parameters are corrected according to fitting accuracy to finally determine optimal parameter values.

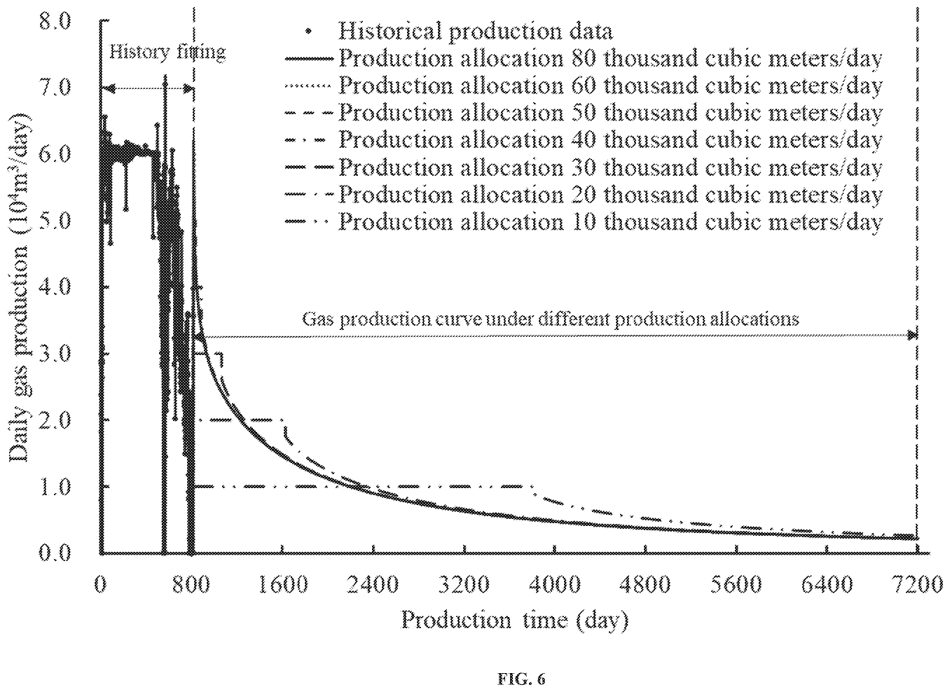

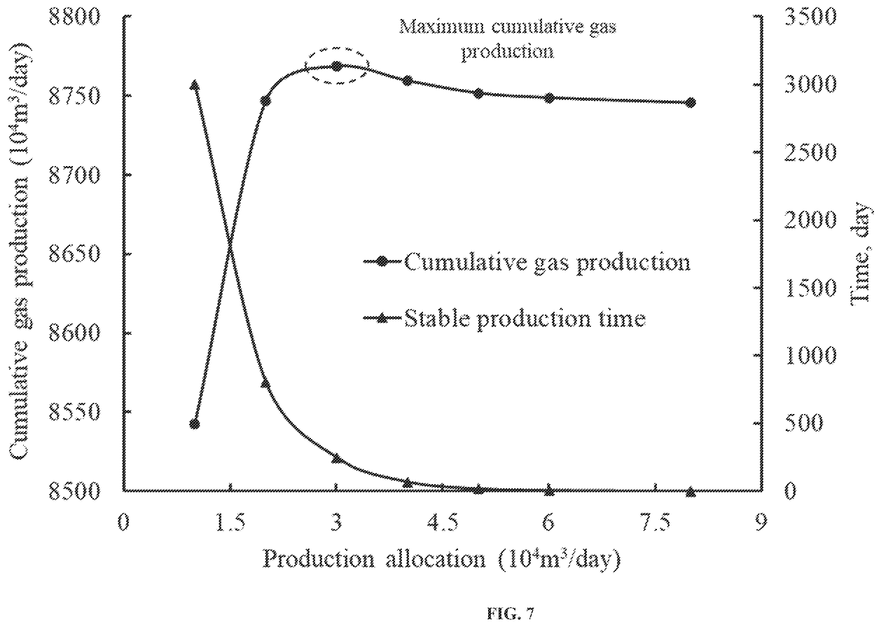

Based on the optimal parameter values obtained at the production history fitting stage, production simulation is then performed in a production mode of fixing production first and then fixing pressure, with a minimum flowing bottom-hole pressure of 5 MPa. Subsequently, production is allocated by 8.0*10⁴ m³/d, 6.0*10⁴ m³/d, 5.0*10⁴ m³/d, 4.0*10⁴ m³/d, 3.0*10⁴ m³/d, 2.0*10⁴ m³/d, and 1.0*10⁴ m³/d. The production proceeds yearly for 360 days, and a gas production changing curve of the shale gas well under different production allocation conditions is predicted (as shown in FIG. 6). Based on the cumulative gas productions (as shown in FIG. 7) under different production allocation conditions, it is reasonable that the recommended production allocation is 3.0*10⁴ m³/d for this well, and it is predicted that the cumulation gas production of 20 years is 8768.641*10⁴ m³.

The above disclosed are only preferred embodiments of the present disclosure, and definitely should not be used to limit the scope of the claims of the present disclosure. A person of ordinary skill in the art can understand all or some of the procedures for implementing the foregoing embodiments and make equivalent changes according to the claims of the present disclosure. The equivalent changes still fall within the scope of the present disclosure.

What is claimed is:

1. A yield prediction method for a fractured horizontal well based on simulated special mechanisms of shale gas, comprising the following steps:
establishing a gas-phase seepage model of a shale reservoir matrix system with consideration of special mechanisms;
establishing gas-phase and water-phase seepage models of a shale reservoir fracture system with consideration of special mechanisms;
establishing a gas-water two-phase seepage model of a shale gas well based on the gas-phase seepage model of the shale reservoir matrix system and the gas-phase and water-phase seepage models of the shale reservoir fracture system;
solving the gas-water two-phase seepage model of the shale gas well by using a numerical simulation method to obtain a yield of the shale gas well;
performing production history fitting by adjusting related parameters; and
performing production simulation and yield prediction under different production allocations according to parameter values obtained after the production history fitting.

2. The yield prediction method for a fractured horizontal well based on simulated special mechanisms of shale gas according to claim 1, wherein the establishing a gas-phase seepage model of a shale reservoir matrix system with consideration of special mechanisms of Knudsen diffusion, surface diffusion, slippage effect, and desorption influenced by a fracturing fluid comprises:
establishing a shale gas desorption model under the influence of the fracturing fluid, and unifying units of the shale gas desorption model to m³/m³ to obtain:
$${V}_{ab} = \{ ( 1 - {θ}_{w} ) {V}_{1} exp \{ - {[ \frac{RT}{E} ln ( \frac{{{P}_{c} ( T / {T}_{c} )}^{m}}{P} ) ]}^{K} \} + {V}_{c} \} {ρ}_{rock} \times {10}^{- 3}$$
wherein P represents a reservoir pressure, MPa; R represents a gas constant, 8.314 J/(mol·K); T represents a reservoir temperature, K; V_{ab} represents an absolute adsorbed gas quantity of an adsorbent, m³/t; E represents adsorption characteristic energy, J/mol; P_{c} represents a critical pressure of methane, 4.59 MPa; T_{c} represents a critical temperature of methane, 190.55K; m represents an adsorption system coefficient, dimensionless; κ represents a surface adsorption potential maldistribution coefficient of the adsorbent, which is 2 to 6; V₁ represents a maximum gas adsorption quantity when θ_{w}=0, m³/t; θ_{w} represents a surface coverage of water; V_{c} represents a residual gas adsorption quantity, m³/t; and Pₘ represents a test pressure or a pressure in matrix pores, MPa;
comprehensively characterizing a transport mechanism of the shale gas in matrix nanopores by using an apparent permeability, wherein the transport mechanism comprises Knudsen diffusion, surface diffusion, sliding flow, and viscos flow, and deriving the following equation:
$${K}_{m} = \frac{{ϕ}_{m}}{τ} \{ \frac{{r}^{2} ( 1 + α K \text{?} )}{8 ( 1 + K \text{?} )} ( 1 + \frac{4 {K}_{n}}{1 - {bK}_{n}} ) + \frac{2 {μ}_{g} r}{3 {ρ}_{g} ( 1 + \frac{1}{{K}_{n}} )} \sqrt{\frac{8 M}{RT π}} + \frac{{μ}_{g} {D}_{s} {ρ}_{rock} {ρ}_{st} {V}_{ab} ( 1 - {ϕ}_{m} )}{( 1 - {θ}_{g} ) {P}_{m}} ∇ {P}_{m} \}$$
$$\text{?} \text{indicates text missing or illegible when filed}$$
wherein Kₘ represents the apparent permeability, μm²; Kₙ represents a Knudsen number; ϕₘ represents a matrix porosity, dimensionless; τ represents a tortuosity of nanopores, dimensionless; μ_{g} represents a gas viscosity in pores, mPa·s; α represents a rare effect coefficient, dimensionless; ϕ represents a shale porosity, %; Ds represents a surface diffusion coefficient of the shale gas, m²/s; ρ_{rock} and ρₛₜ represent a rock density and a gas density under standard conditions, respectively, kg/m³; r represents a matrix pore radius, nm; ρ_{g} represents a gas density, kg/m³; b represents a slip coefficient, b=−1; θ_{g} represents a surface coverage of a gas phase; and M represents a molecular mass of a gas, g/mol⁻¹;
wherein the rare effect coefficient is expressed as:
$$α = \frac{128}{15 {π}^{2}} {tan}^{- 1} ( 4 {Kn}^{0.4} )$$
the surface diffusion coefficient of the shale gas is expressed as:
$${D}_{s} = \frac{8.29 \times {10}^{- 7} \sqrt{T} exp ( - \frac{{ΔΓ}^{0.8}}{RT} )}{1 - {θ}_{g}} :$$
wherein ΔΓ represents isosteric heat of adsorption, J/mol;
establishing the gas-phase seepage model of the shale reservoir matrix system, and transforming the gas-phase seepage model of the shale reservoir matrix system into an equation of continuity of two-dimensional plane flow as follows:
$$\frac{\partial }{\partial x} ( {A}_{x} \frac{{K}_{m} {ρ}_{g}}{{μ}_{g}} \frac{\partial {P}_{m}}{\partial x} ) Δ x + \frac{\partial }{\partial y} ( {A}_{y} \frac{{K}_{m} {ρ}_{g}}{{μ}_{g}} \frac{\partial {P}_{m}}{\partial y} ) Δ y = {V}_{b} \frac{\partial }{\partial t} ( {ϕ}_{m} {ρ}_{g} + {ρ}_{gsc} {V}_{ab} ) - {q}_{c}$$
wherein q_{c} represents a gas channeling quantity between the shale reservoir matrix system and the shale reservoir fracture system, kg/s; Pₘ represents the pressure in the matrix pores, MPa; ρ_{gsc} represents a natural gas density in a standard state, kg/m³; Aₓ and A_{y} represent cross-sectional areas of a grid in an x-direction and a y-direction, respectively, m²; Δt represents a time step size, d; and V_{b} represents a volume of a grid block, m³;
wherein the gas channeling quantity is expressed as:
$${q}_{c} = \frac{2 Δ z Δ {xK}_{m} {ρ}_{g}}{Δ y {μ}_{g}} ( {P}_{m} - {P}_{fg} )$$
wherein Δx represents a size of a grid block of a matrix apparent permeability in the x-direction; Δy represents a size of the grid block of the matrix apparent permeability in the y-direction; Δz represents a size of the grid block of the matrix apparent permeability in a z-direction; and P_{fg} represents a gas phase pressure in a fracture, MPa.

3. The yield prediction method for a fractured horizontal well based on simulated special mechanisms of shale gas according to claim 2, wherein the establishing gas-phase and water-phase seepage models of a shale reservoir fracture system with consideration of influences of a sanding concentration, a particle size of a proppant, and a closure stress comprises:
revealing an artificial fracture deformation regularity caused by different factors through a real rock slab flow conductivity experiment, and establishing a reliable quantitative description equation, wherein the flow conductivity F_{CD} of a fracture is expressed as:
$${F}_{CD} = \frac{{C}_{p}}{5} {F}_{CD 0} {e}^{- {C}_{f} ( {P}_{c} - {P}_{c 0} )} = {K}_{f} {W}_{f}$$
wherein F_{CD} represents the flow conductivity of a prop fracture under the action of a current closure stress, D·cm; F_{CDO} represents the flow conductivity of the prop fracture under an initial closure stress, D·cm; C_{f} represents a stress sensitivity coefficient of a shale fracturing fracture, MPa⁻¹; P_{c} represents the current closure stress, MPa; P_{co} represents the initial closure stress, MPa; Cₚ represents a sanding concentration of the proppant, kg/m²; K_{f} represents a permeability of the prop fracture, μm²; and W_{f} represents a width of the prop fracture, m;
establishing the gas-phase and water-phase seepage models of the shale reservoir fracture system, and transforming the gas-phase and water-phase seepage models of the shale reservoir fracture system into equations of continuity of two-dimensional plane flow as follows:
gas phase:
$$\frac{\partial }{\partial x} ( {A}_{x} \frac{{K}_{f} {K}_{frg} {ρ}_{g}}{{μ}_{fg}} \frac{\partial {P}_{fg}}{\partial x} ) Δ x + \frac{\partial }{\partial y} ( {A}_{y} \frac{{K}_{f} {K}_{frg} {ρ}_{g}}{{μ}_{fg}} \frac{\partial {P}_{fg}}{\partial y} ) Δ y = {V}_{b} \frac{\partial }{\partial t} ( {ϕ}_{f} {ρ}_{g} {S}_{fg} ) + {q}_{c} - {q}_{g}$$
water phase:
$$\frac{\partial }{\partial x} ( {A}_{x} \frac{{K}_{f} {K}_{frw} {ρ}_{w}}{{μ}_{fw}} \frac{\partial {P}_{fw}}{\partial x} ) Δ x + \frac{\partial }{\partial y} ( {A}_{y} \frac{{K}_{f} {K}_{frw} {ρ}_{w}}{{μ}_{fw}} \frac{\partial {P}_{fw}}{\partial y} ) Δ y = {V}_{b} \frac{\partial }{\partial t} ( {ϕ}_{f} {ρ}_{w} {S}_{fw} ) - {q}_{w}$$
wherein K_{frg} represents a relative permeability of the gas phase in the fracture, μm²; K_{frw} represents a relative permeability of the water phase in the fracture, μm₂; S_{fg} represents a water saturation of the shale reservoir fracture system, %; S_{fw} represents a water saturation of the shale reservoir fracture system, %; ϕ_{f} represents a fracture porosity, %; q_{w} represents a mass flow rate of water flowing from the fracture into a wellbore, kg/s; q_{g} represents a mass flow rate of gas flowing from the fracture into the wellbore, kg/s; and μ_{fw} represents a viscosity of the water phase in the fracture, mPa·s.

4. The yield prediction method for a fractured horizontal well based on simulated special mechanisms of shale gas according to claim 3, wherein the establishing a gas-water two-phase seepage model of a shale gas well based on the gas-phase seepage model of the shale reservoir matrix system and the gas-phase and water-phase seepage models of the shale reservoir fracture system comprises:
expressing the mass flow rates of the gas phase and the water phase flowing from the fracture into the wellbore by the following two formulas, and characterizing the mass flow rates of gas and water flowing from the fracture into the wellbore in a grid of a producing well by the two formulas:
$${q}_{g} = \frac{2 {πρ}_{g} {K}_{f} {K}_{frg} {W}_{f}}{{μ}_{fg} ( ln \frac{{r}_{eq}}{{r}_{w}} + S )} ( {P}_{HE} - {P}_{wf} )$$
$${q}_{w} = \frac{2 {πρ}_{w} {K}_{f} {K}_{frw} {W}_{f}}{{μ}_{w} ( ln \frac{{r}_{eq}}{{r}_{w}} + S )} ( {P}_{HE} - {P}_{wf} )$$
wherein r_{eq} represents an equivalent bottom-hole radius, m; r_{w} represents a well radius, which is 0.1 m; P_{HE} represents a pressure of a grid block where the wellbore is located, MPa; P_{wf} represents a flowing bottom-hole pressure, MPa; and S represents a skin coefficient, dimensionless; and
combining the equation of continuity for the gas phase established in the shale reservoir matrix system and the equations of continuity for gas and water established in the shale reservoir fracture system to obtain a basic seepage equation of shale gas with consideration of a special seepage mechanism:
$$\{ \begin{matrix}\frac{\partial }{\partial x} ( {A}_{x} \frac{{K}_{m} {ρ}_{g}}{{μ}_{g}} \frac{\partial {P}_{m}}{\partial x} ) Δ x + \frac{\partial }{\partial y} ( {A}_{y} \frac{{K}_{m} {ρ}_{g}}{{μ}_{g}} \frac{\partial {P}_{m}}{\partial y} ) Δ y = {V}_{b} \frac{\partial }{\partial t} ( {ϕ}_{m} {ρ}_{g} + \\ {ρ}_{gsc} {V}_{ab} ) - {q}_{c} \\ \frac{\partial }{\partial x} ( {A}_{x} \frac{{K}_{f} {K}_{frg} {ρ}_{g}}{{μ}_{g}} \frac{\partial {P}_{fg}}{\partial x} ) Δ x + \frac{\partial }{\partial y} ( {A}_{y} \frac{{K}_{f} {K}_{frg} {ρ}_{g}}{{μ}_{g}} \frac{\partial {P}_{fg}}{\partial y} ) Δ y = \\ {V}_{b} \frac{\partial }{\partial t} ( {ϕ}_{f} {ρ}_{g} {S}_{fg} ) + {q}_{c} - {q}_{g} \\ \frac{\partial }{\partial x} ( {A}_{x} \frac{{K}_{f} {K}_{frw} {ρ}_{w}}{{μ}_{fw}} \frac{\partial {P}_{fw}}{\partial x} ) Δ x + \frac{\partial }{\partial y} ( {A}_{y} \frac{{K}_{f} {K}_{frw} {ρ}_{w}}{{μ}_{fw}} \frac{\partial {P}_{fw}}{\partial y} ) Δ y = \\ {V}_{b} \frac{\partial }{\partial t} ( {ϕ}_{f} {ρ}_{w} {S}_{fw} ) - {q}_{w}\end{matrix}$$
wherein before numerical simulation and solving of the basic seepage equation of shale gas, an initial condition and a boundary condition are defined; definite conditions of models comprise boundaries conditions and initial conditions of the shale reservoir fracture and matrix systems, and assuming that the initial pressures of the shale reservoir fracture and matrix systems are the same, an initial pressure condition is obtained as follows:
$${P}_{k} ( x , y , t ) {\vert}_{t = 0} = {P}_{m} ( x , y , t ) {\vert}_{t = 0} = {P}_{f} ( x , y , t ) {\vert}_{t = 0} = {P}_{i}$$
since a research object is an enclosed unit, an outer boundary of a mathematical model is enclosed, and an inner boundary is production under a fixed flowing bottom-hole pressure, and an inner boundary condition of the model is as follows:
$$\frac{\partial {P}_{f}}{\partial n} {\vert}_{{Γ}_{I}} = {P}_{wf}$$
and an outer boundary condition is as follows:
$$\frac{\partial {P}_{f}}{\partial n} {\vert}_{{Γ}_{o}} = 0 , \frac{\partial {P}_{m}}{\partial n} {\vert}_{{Γ}_{o}} = 0 , \frac{\partial {P}_{k}}{\partial n} {\vert}_{{Γ}_{o}} = 0$$
wherein Γ_{I} and Γₒ represent the outer boundary and inner boundary conditions, respectively.

5. The yield prediction method for a fractured horizontal well based on simulated special mechanisms of shale gas according to claim 4, wherein the solving the gas-water two-phase seepage model of the shale gas well by using a numerical simulation method to obtain a yield of the shale gas well comprises:
discretizing the equations in a format of block centered finite difference by using an implicit pressure explicit saturation (IMPES) difference method to obtain corresponding difference equations:
a gas-phase difference equation of the shale reservoir matrix system:
$${T}_{mxi + \frac{1}{2} , j} ( {P}_{m i + 1 , j}^{n + 1} - {P}_{m i , j}^{n + 1} ) - {T}_{mxi - \frac{1}{2} , j} ( {P}_{m i , j}^{n + 1} - {P}_{m i - 1 , j}^{n + 1} ) + {T}_{myi , j + \frac{1}{2}} ( {P}_{m i , j + 1}^{n + 1} - {P}_{m i , j}^{n + 1} ) - {T}_{myi , j - \frac{1}{2}} ( {P}_{m i , j}^{n + 1} - {P}_{m i , j - 1}^{n + 1} ) = \frac{{V}_{b}}{Δ t} {\overline{C}}_{mt} ( {P}_{fgi , j}^{n + 1} - {P}_{fgi , j}^{n} ) - {q}_{c}^{n}$$
a gas-phase difference equation of the shale reservoir fracture system:
$${T}_{fgxi + \frac{1}{2} , j} ( {P}_{fgi + 1 , j}^{n + 1} - {P}_{fgi , j}^{n + 1} ) - {T}_{fgxi - \frac{1}{2} , j} ( {P}_{fgi , j}^{n + 1} - {P}_{fgi - 1 , j}^{n + 1} ) + {T}_{fgyi , j + \frac{1}{2}} ( {P}_{fgi , j + 1}^{n + 1} - {P}_{fgi , j}^{n + 1} ) - {T}_{fgyi , j - \frac{1}{2}} ( {P}_{fgi , j}^{n + 1} - {P}_{fgi , j - 1}^{n + 1} ) = \frac{{V}_{b}}{Δ t} {ϕ}_{f} {ρ}_{g} ( {C}_{f} + {C}_{fg} {S}_{fg} ) ( {P}_{fgi , j}^{n + 1} - {P}_{fgi , j}^{n} ) - {q}_{g}^{n} + {q}_{c}^{n}$$
a water-phase difference equation of the shale reservoir fracture system:
$${T}_{fwxi + \frac{1}{2} , j} ( {P}_{fwi + 1 , j}^{n + 1} - {P}_{fwi , j}^{n + 1} ) - {T}_{fwxi - \frac{1}{2} , j} ( {P}_{fwi , j}^{n + 1} - {P}_{fwi - 1 , j}^{n + 1} ) + {T}_{fwyi , j + \frac{1}{2}} ( {P}_{fwi , j + 1}^{n + 1} - {P}_{fwi , j}^{n + 1} ) - {T}_{fwyi , j - \frac{1}{2}} ( {P}_{fwi , j}^{n + 1} - {P}_{fwi , j - 1}^{n + 1} ) = \frac{{V}_{b}}{Δ t} {ϕ}_{f} {ρ}_{fw} ( {C}_{f} + {C}_{fw} {S}_{fw} ) ( {P}_{fwi , j}^{n + 1} - {P}_{fwi , j}^{n} ) - {q}_{w}^{n}$$
$$where$$
$${T}_{mxi + \frac{1}{2} , j} = {{A}_{x} ( \frac{{K}_{m} {ρ}_{g}}{{μ}_{g}} )}_{i \pm \frac{1}{2} , j} \frac{Δ {y}_{j}}{Δ {x}_{i \pm \frac{1}{2} , j}}$$
$$and$$
$${T}_{myi , j \pm \frac{1}{2}} = {A}_{y} \frac{{( \frac{{K}_{m} {ρ}_{m g}}{{μ}_{g}} )}_{i , j \pm \frac{1}{2}}}{Δ {y}_{i , j \pm \frac{1}{2}}}$$
represent conductivities of gas in the x-direction and the y-direction of the shale reservoir matrix system, respectively;
$${T}_{fgxi \pm \frac{1}{2} , j} = {{A}_{x} ( \frac{{K}_{f} {K}_{frg} {ρ}_{fg}}{{μ}_{fg}} )}_{i \pm \frac{1}{2} , j} \frac{Δ {y}_{j}}{Δ {x}_{i \pm \frac{1}{2} , j}}$$
$$and$$
$${T}_{fgyi , j \pm \frac{1}{2}} = {A}_{y} \frac{{( \frac{{K}_{f} {K}_{frg} {ρ}_{fg}}{{μ}_{fg} Δ y} )}_{i , j \pm \frac{1}{2}}}{Δ {y}_{i , j \pm \frac{1}{2}}}$$
represent conductivities of gas in the x-direction and the y-direction of the shale reservoir fracture system, respectively;
$${T}_{fwxi \pm \frac{1}{2} , j} = {{A}_{x} ( \frac{{K}_{f} {K}_{frw} {ρ}_{w}}{{μ}_{fw}} )}_{i \pm \frac{1}{2} , j} \frac{Δ {y}_{j}}{Δ {x}_{i \pm \frac{1}{2} , j}}$$
$$and$$
$${T}_{fwyi , j \pm \frac{1}{2}} = {A}_{y} \frac{{( \frac{{K}_{f} {K}_{frw} {ρ}_{w}}{{μ}_{fw} Δ y} )}_{i , j \pm \frac{1}{2}}}{Δ {y}_{i , j \pm \frac{1}{2}}}$$
represent conductivities of the water phase in the x-direction and the y-direction of the shale reservoir fracture system, respectively;
$${\overline{C}}_{mt} = {ϕ}_{m} {ρ}_{m g} {C}_{mt} + {ρ}_{gsc} \frac{{V}_{ab}}{\partial {P}_{m}}$$
represents a total compressibility of the matrix, MPa⁻¹; C_{f} represents a total compressibility of the shale reservoir fracture system, MPa⁻¹; C_{fw} represents a coefficient of compressibility of the water phase in the shale reservoir fracture system, MPa⁻¹; C_{fg} represents a coefficient of compressibility of the gas phase in the shale reservoir fracture system. MPa⁻¹; P_{fg} represents a gas-phase pressure in the fracture. MPa; P_{fw} represents a water-phase pressure in the fracture. MPa; and Cₘₜ represents a coefficient of compressibility when adsorption and desorption are not considered in the matrix. MPa⁻¹.
